(19) United States
(12) Patent Application Publication
(10) Pub. No.: US 2009/0263123 A1
(43) Pub. Date: Oct. 22, 2009

(54) FIBER NETWORK MONITORING

(75) Inventors: Tian Zhu, Castro Valley, CA (US); Pei-Ling Wu, Taipei (TW); Peng Wang, Shanghai (CN)

Correspondence Address: FISH & RICHARDSON P.C., PO BOX 1022, MINNEAPOLIS, MN, 55440-1022, US

(73) Assignee: OPLINK COMMUNICATIONS, INC., Fremont, CA (US)

(21) Appl. No.: 12/122,613

(22) Filed: May 16, 2008

(30) Foreign Application Priority Data
Apr. 21, 2008 (CN) PCT/CN2008/000817

(51) Int. Cl. H04B 10/08

(52) U.S. Cl. 398/16; 398/9

(57) ABSTRACT

This specification describes technologies relating to optical fiber network monitoring. A monitoring system is provided. The monitoring system includes a fiber network including a plurality of branch fibers and a main station coupled to a main fiber of the fiber network to broadcast communications signals to a plurality of branch stations. The monitoring system includes a monitoring device configured to transmit a monitoring signal and detect reflected portions of the monitoring signal such that the received portions specifically identify a condition of specific branch fibers of the plurality of branch fibers and a plurality of filtering devices coupled to each respective branch fiber, each filtering device including a transmission window configured to pass a plurality of communication wavelengths and a distinct wavelength of the monitoring signal, where the distinct wavelength is not within the transmission window, and block the remaining wavelengths, where the distinct wavelength identifies the respective branch fiber.

### CROSS-REFERENCE TO RELATED APPLICATIONS

This application claims priority under 35 U.S.C. §119 to PCT Application Serial No. PCT/CN2008/000817, filed on Apr. 21, 2008, to inventors Tian Zhu, Pei-Ling Wu, and Peng Wang, and titled Fiber Network Monitoring.

### BACKGROUND

The present disclosure relates to fiber network monitoring.

Optical fiber networks typically include a main fiber connected to a number of branch fibers. A signal can be broadcast from a source location to multiple destination locations through the fiber network. Typically, the condition of the fiber network is monitored. A monitor can be placed at a location in the network, for example, at the broadcasting location. The monitor remotely monitors, e.g., from the broadcasting location, the condition of the optical fiber network.

Optical time domain reflectometry (“OTDR”) is typically used for inspecting a single fiber. A short pulse of light is transmitted into a fiber using an OTDR device. Backscattered light from the light pulse in the fiber is monitored using the OTDR device for abrupt changes indicative of a fault in the fiber. For a fiber network, since the light pulse splits and propagates to all branches, the detected backscattered light is contributed from all branches. Consequently, even when a fault is detected, the fault may not be able to be identified with reference to a specific branch fiber.

### SUMMARY

This specification describes technologies relating to optical fiber network monitoring. In general, one aspect of the subject matter described in this specification can be embodied in monitoring systems including a fiber network including multiple branch fibers and a main station coupled to a main fiber of the fiber network, the main station configured to broadcast communications signals to multiple branch stations coupled to the respective branch fibers of the multiple branch fibers. The monitoring system also includes a monitoring device configured to transmit a monitoring signal and detect reflected portions of the monitoring signal such that the received portions of the monitoring signal specifically identify a condition of specific branch fibers of the multiple branch fibers and multiple filtering devices coupled to each respective branch fiber, each filtering device including a transmission window configured to pass multiple communication wavelengths and a distinct wavelength of the monitoring signal, where the distinct wavelength is not within the transmission window, and block the remaining wavelengths, where the distinct wavelength identifies the respective branch fiber. Other embodiments of this aspect include corresponding methods and apparatus.

These and other embodiments can optionally include one or more of the following features. The intensity of the monitoring signal can be modulated by a modulating function. The modulating function can be periodic. The monitoring device can include a circulator coupled between a signal source and a receiver.

The monitoring system can further include a splitter configured to separate the monitoring signals into each of the multiple branch fibers. The monitoring system can further include multiple reflecting elements, each reflecting element being positioned in along a corresponding branch fiber, each reflecting element being configured to reflect the particular wavelength passed by the corresponding filtering device of the branch fiber.

Each filtering device can include a first fiber, a first lens for collimating light exiting from the first fiber, a filter for partially transmitting one or more transmission wavelengths and reflecting one or more reflection wavelengths of the collimated light according to a particular transmission function and where the reflection wavelengths do not exit the filtering device, a second lens for focusing filtered light including the one or more transmission wavelengths transmitted by the filter, and a second fiber for receiving focused light focused by the second lens.

The filtering device can be configured to transmit particular wavelengths input to both the first fiber and the second fiber while blocking other wavelengths. The transmission function of the filter includes the transmission window and a defined width peak corresponding to a particular monitoring wavelength, where the transmission window is separated from the peak by a specified range of non-passed wavelengths. The transmission window can be substantially between 1250 nm and 1585 nm. A peak-width can be at a substantially 25% pass ratio of the defined width peak is less than 10 nm. The transmission function of the filter can cover substantially S-band and C-band, and can include a defined width peak substantially between 1561 nm and 1700 nm. The filter can be a thin films filter. The filtering device can be configured for coupling to a fiber connector selected from a group consisting of SC, LC, ST, and MU.

In general, one aspect of the subject matter described in this specification can be embodied in methods that include the actions of receiving in a first direction one or more communications signals, the communications signals having wavelengths within a transmission window, receiving in the first direction a monitoring signal, the monitoring signal including one or more wavelengths distinct from the wavelengths of the transmission window, where the wavelengths of the transmission window and the wavelengths of the monitoring signal are separated by a specified range of wavelengths, passing the communications signals, passing a particular wavelength of the monitoring signal, and blocking all other wavelengths. Other embodiments of this aspect include corresponding systems and apparatus.

These and other embodiments can optionally include one or more of the following features. The method can further include receiving from a second direction a reflected monitoring signal and passing the reflected monitoring signal. The intensity of the monitoring signal can be modulated by a modulating function.

In general, one aspect of the subject matter described in this specification can be embodied in an apparatus that include a thin films filter having a specified transmission function including a transmission window covering an S-band and a C-band and a defined width peak at a specified wavelength corresponding to a particular monitoring signal and not within the transmission window.

These and other embodiments can optionally include the following feature. The apparatus can be configured for coupling to a fiber connector selected from a group consisting of SC, LC, ST, and MU.

In general, one aspect of the subject matter described in this specification can be embodied in a system that includes a source configured to provide an optical signal having multiple wavelengths; multiple filters disposed in distinct locations within an optical fiber network, each filter for partially transmitting one or more transmission wavelengths of the optical signal and reflecting one or more reflection wavelengths of the optical signal according to a particular transmission function, where the transmission function of each filter of the multiple filters includes a transmission window including one or more communication wavelengths and a distinct transmission peak corresponding to a respective monitoring wavelength for the respective filter; and a monitor configured to identify problems at particular locations in the optical fiber network according to wavelengths of the optical signal returned from the multiple filters. Other embodiments of this aspect include corresponding methods and apparatus.

These and other embodiments can optionally include the following feature. An intensity of the optical signal can be modulated by a modulating function.

Particular embodiments of the subject matter described in this specification can be implemented to realize one or more of the following advantages. A filtering device is provided for monitoring and identifying individual branches in a fiber network that is relatively inexpensive, easily installable, and simple to operate.

The filtering device can include multiple ports that can be mated to various types of fiber connectors. Thus, an installer can easily add or change the filtering device in a fiber network. The filtering device can be used for identifying and monitoring individual branch in a fiber network at substantially the same time. The filter can be designed and manufactured to provide a transmission window for communication signals and a narrow transmission peak for a monitoring signal with a specific wavelength encoding a specific branch in a fiber network. Collimating optics for the filtering device can be designed and packaged to provide a very narrow width of the transmission peak such that the peak-width at substantially a 25% level can be 1 nm or less. Additionally, the packaging of the filtering device can take advantage of the matured technology for WDM device packaging, which can be stable in wide ranges of temperature and humidity.

Accumulated leaking signals from all branches in the fiber network can generate a false alarm. The wavelength filtering device can filter the optical signal twice in both the forward and backward direction. Thus, the filter passes one specific composite wavelength and rejects other composite wavelengths of the monitoring signal in both directions. The leakage of other composite wavelengths can be suppressed.

The intensity of a monitoring signal can be modulated to increase a signal-to-noise ratio. In the event of a fault including a broken or damaged optical fiber, the reflected intensity-modulated signal can provide information to infer the fault's location without using an expensive OTDR device.

The details of one or more embodiments of the invention are set forth in the accompanying drawings and the description below. Other features, aspects, and advantages of the invention will become apparent from the description, the drawings, and the claims.

### BRIEF DESCRIPTION OF THE DRAWINGS

FIG. 1 shows a block diagram of an example optical fiber network using conventional monitoring.

FIG. 2 shows a block diagram of an example fiber network including individual branch monitoring.

FIG. 3 shows a flowchart of an example method for monitoring branches in an optical fiber network.

FIG. 4 shows a display of an example transmission function of a filter for identifying and monitoring individual branches in a fiber network.

FIG. 5 shows a block diagram of an example thin films filter.

FIG. 6 shows an example transmission function for a filter.

FIG. 7 shows an example filtering device.

FIG. 8 shows an example filtering device mating to fiber connectors.

FIG. 9 shows an example monitoring device.

Like reference numbers and designations in the various drawings indicate like elements.

### DETAILED DESCRIPTION

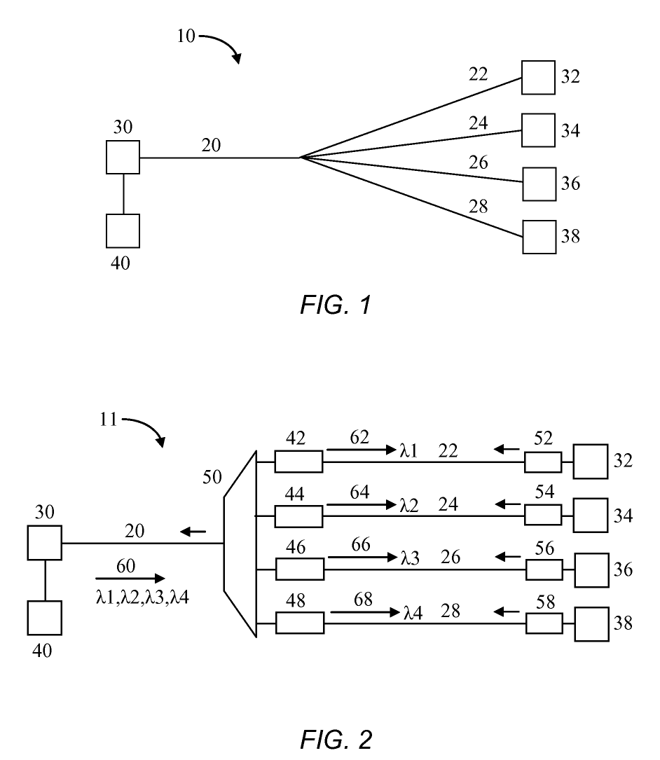

FIG. 1 shows a block diagram of an example optical fiber network 10 using conventional monitoring. The optical fiber network 10 includes a main fiber 20 coupled to multiple branch fibers, for example, four branch fibers 22, 24, 26, and 28. Each of the branch fibers 22, 24, 26, and 28 is coupled to a respective branch station 32, 34, 36, and 38. Through the main fiber 20 and branch fibers 22, 24, 26, and 28, the network 10 joins a main station 30 and the branch stations 32, 34, 36, and 38.

In some implementations, the optical fiber network 10 can be a passive optical network (“PON”) for “fiber to the x” (“FTTX”) applications. The main station 30 can be, for example, an optical line terminal (“OLT”), and branch stations 32, 34, 36, or 38 can each be an optical network unit (“ONU”).

A monitoring device 40 is positioned relative to the main station 30 for monitoring the condition of the network. For example, the monitoring device 40 can be part of the main station 30 or coupled to the main station 30. Monitoring the condition of the network includes monitoring whether the connections between the main station 30 and the branch stations 22, 24, 26, and 28 are in normal condition (i.e., no disconnections, unexpected losses, or other faults). However, the conventional monitoring device 40 using for example optical time domain reflectometry, only monitors the fiber network as a whole and can not monitor individual branch fibers.

FIG. 2 shows a block diagram of an example optical fiber network 11 including individual branch monitoring. The optical fiber network 11 also includes a main fiber 20 connected to branch fibers 22, 24, 26, and 28, through an optical splitter 50. Through the main fiber 20 and branch fibers 22, 24, 26, and 28, the network 11 joins a main station 30 and branch stations 32, 34, 36, and 38. In addition, the optical fiber network 11 includes wavelength filtering devices 42, 44, 46, and 48 positioned along respective branch fibers 22, 24, 26, and 28.

Similar to the network 10 of FIG. 1, the network 11 in FIG. 2 can be a passive optical network (“PON”) for a FTTX application. The main station 30 can be an OLT, and one or more of the branch stations 32, 34, 36, or 38 can be ONU's.

A monitoring device 40 is positioned in or near the main station 30 for monitoring the condition of the optical fiber network 11. The monitoring can include determining whether the connections between the main station and all branch stations are in normal condition (e.g., no disconnections, unexpected losses, or other faults occurring in the network).

In some implementations, the monitoring device 40 can emit a monitoring signal 60 through main fiber 20. The monitoring signal 60 can be composed of multiple wavelengths corresponding to a number of monitored branches, for example, four wavelengths, λ1, λ2, λ3, and λ4 for monitoring branch fibers 22, 24, 26, and 28, respectively. The splitter 50 splits the monitoring signal 60 into each of the branch fibers 22, 24, 26, and 28.

In some implementations, the monitoring device 40 can emit a series of monitoring signals 60 sequentially, in which each signal has only one distinct wavelength, for example, λ1, λ2, λ3, and λ4.

A wavelength filtering device can be positioned along the optical path of each respective branch fiber. For example, a wavelength filtering device 42 can be positioned in the optical path 22 between the splitter 50 and the branch station 32. The wavelength filtering device 42 can include two ports. Each port is connected in-line with branch fiber 22. The filtering device 42 transmits only one wavelength, e.g., λ1, of the four composite wavelengths λ1, λ2, λ3, and λ4 in the monitoring signal 60. The filtering device 42 blocks the other wavelengths (e.g., λ2, λ3, and λ4). Therefore, the filtering device 42 passes a filtered signal 62 having only one wavelength, e.g., λ1.

Similarly, each other branch fiber includes a respective wavelength filtering device transmitting a single wavelength of the monitoring signal 60. Branch fiber 24 includes wavelength filtering device 44, which transmits filtered signal 64 having wavelength λ2. Branch fiber 26 includes wavelength filtering device 46, which transmits filtered signal 66 having wavelength λ3 and branch fiber 28 includes wavelength filtering device 48, which transmits filtered signal 68 having wavelength λ4.

A reflecting element 52 is disposed in the optical path 22 between filtering device 42 and station 32. In some implementations, the reflecting element 52 can be a device having two ports, which are also connected to fiber 22. In some other implementations, the reflecting element 52 can be an additional coating on a surface of any element between filtering device 42 and the station 32. The reflecting element 52 can either reflect the signal with any wavelength of λ1, λ2, λ3, and λ4, or one specific wavelength only, e.g., λ1, while passing optical communication signals of the fiber network. Communication signals will be discussed in greater detail below.

When the branch fiber 22 is in normal condition, e.g., no fault in branch fiber 22, the reflecting element 52 reflects the filtered signal 62. The reflected signal passes back through the filtering device 42 and the splitter 50. From the splitter 50, the filtered signal 62 propagates back in main fiber 20 and is detected using the monitoring device 40 (e.g., at the main station 30).

If there is a problem (e.g., a fault) in fiber 22 (optical path 22), the filtered signal 62 of λ1 will not return to, and will not be detected by, the monitoring device 40. Alternatively, the returned filtered signal 62 can have a large loss such that only a very weak signal is returned to the monitoring device 40. Each branch reflects only a specific wavelength. Therefore, the detection of the reflected filtered signal having a specific wavelength allows monitoring of the condition of that specific branch from the main station 30. Conversely, if there is a problem in a specific branch of the network, the signal of the corresponding wavelength will suffer from severe loss or be undetected.

Since an optical fiber network is generally used for transmitting communication signals from one location to another location, these communication signals pass through the wavelength filtering devices 42, 44, 46, or 48 without significant loss. For example, typical communications signals are transmitted in an S-band (1280-1350 nm) and C-band (1528-1561 nm). Therefore, in some implementations, the filtering devices 42, 44, 46, and 48 have two transmission windows covering S-band and C-band, respectively. Alternatively, in some other implementations the filtering devices 42, 44, 46, and 48 have a single transmission window covering substantially 1280-1561 nm.

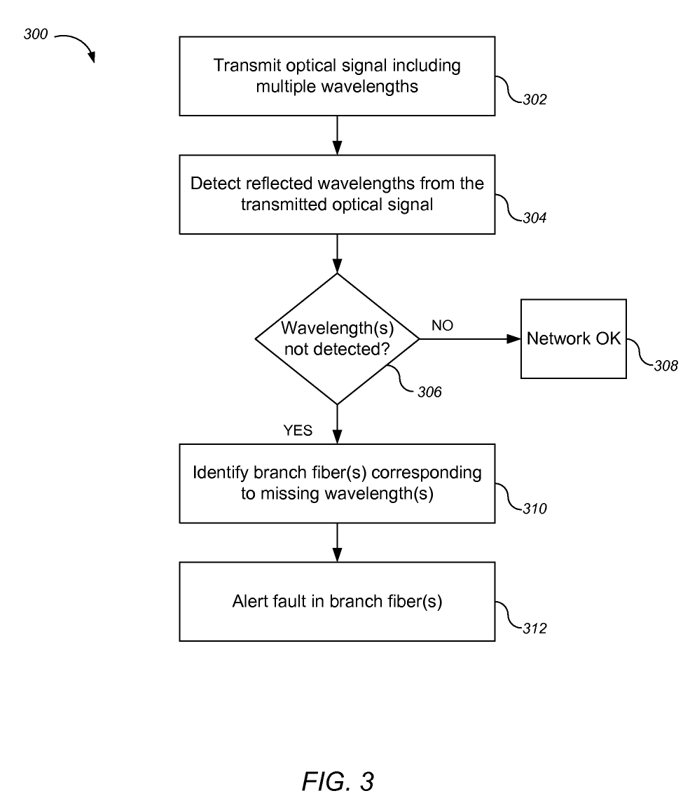

FIG. 3 is a flow chart of an example method 300 for monitoring branches in an optical fiber network. For convenience, the method 300 is described with respect to a device that performs the monitoring (e.g., monitoring device 40 of FIG. 2).

The monitoring device transmits 302 an optical signal having multiple distinct wavelengths. In some implementations, the monitoring device transmits an optical signal having a number of distinct wavelengths equal to the number of branch fibers to be monitored. The wavelengths of the optical signal can be outside the range of wavelengths used for data communication on the optical fiber network.

The monitoring device detects 304 reflected wavelengths from the transmitted optical signal. The reflected wavelengths are returned, for example, after being filtered into individual branches of the fiber network, for example, using a splitter and filtering device (e.g., splitter 50 and filtering device 42 in FIG. 2) and reflected back using a reflecting element (e.g., reflecting element 52 in FIG. 2).

The monitoring device determines 306 whether one or more wavelengths of the transmitted optical signal are not detected. Alternatively, the monitoring device can determine whether or not a received wavelength has a signal strength less than a specified threshold, indicating a high level of loss caused by a problem in a corresponding optical branch fiber.

If all of the wavelengths are detected, then all the branches of the optical fiber network are functioning 308. However, if one or more wavelengths are not detected, or are weakly detected, the monitoring device identifies 310 the branch fibers corresponding to the missing/weak wavelengths. Each branch fiber uses a filtering device to pass a particular wavelength of the signal transmitted from the monitoring device. The monitoring device can therefore identify which branch fiber corresponds to the missing or weak wavelengths.

The monitoring device generates 312 an alert identifying a fault in branch fibers of the fiber network corresponding to the missing or weak wavelengths. In some implementations, the alert can be a signal to a network administrator, an alarm, logging the fault, or other action.

In some implementations, the monitoring device can monitor the fiber network including transmitting the optical signal at various intervals. For example, the monitoring can be frequent or occasional. In some implementations, monitoring is triggered using some other indication of network performance, for example, weaker than expected signal strength at one or more branch stations (e.g., branch stations 32, 34, 36, and 38).

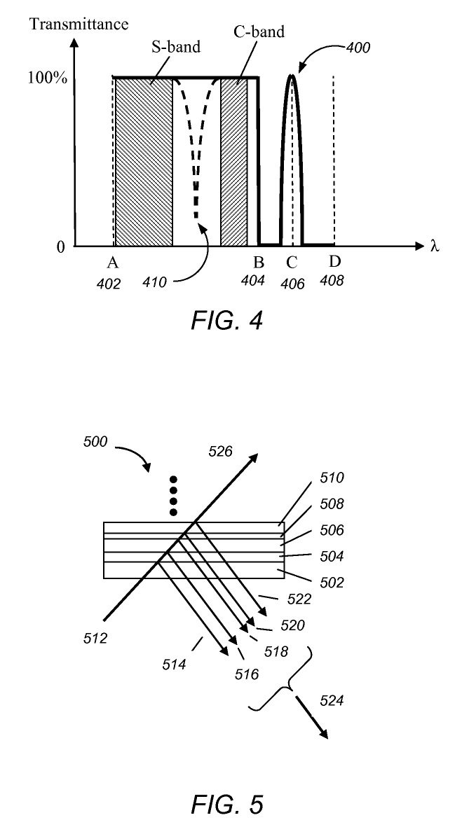

FIG. 4 shows a display of an example transmission function 400 of a filtering device (e.g., filtering device 42) in linear scale. The transmission function 400 is presented with respect to wavelength on the x-axis and transmittance on the y-axis. The filtering device transmits light in a transmission window from point A 402 (e.g., substantially 1280 nm) to B 404 (e.g., substantially 1585 nm or any wavelength between 1561 nm and 1585 nm). The window from point A 402 to point B 404 substantially covers the wavelengths used for communication signals. Additionally, light with a specific wavelength or narrow range of wavelengths at point C 406 (e.g., C=λ1=1602 nm with a width of 1 nm at 25% level) is transmitted. Light that is not transmitted from the filtering device (e.g., light wavelengths outside the transmission window) is blocked, e.g., reflected back off axis.

In some implementations, the transmission function 400 covers an S-band (1280-1350 nm) and a C-band (1528-1561 nm) wavelengths. In some other implementations, the transmission function 400 includes a range of wavelengths from substantially 1350 nm to substantially 1528 nm, which is the gap between the S-band and C-band, can be any value, since there is no communication signal in this wavelength span. For example, a transmission function 410 (dashed line) in the interval of substantially 1350 nm to substantially 1528 nm can be a curved transmission function, or any other transmission function.

In some implementations, the filtering device is configured to be applied to optical signals within a wavelength span from point A 402 to point D 408. Consequently, only the transmission function 400 in the wavelength domain from point A 402 to point D 408 is of interest. The corresponding wavelengths of point A<B<C<D, such that the wavelength λ1 at point C 406 is not inside the transmission window between point A 402 and point B 404. The window from point A 402 to point B 404 covers the S-band and C-band, and wavelength λ1 at point C 406 corresponds to a wavelength of a particular monitoring signal (e.g., monitoring signal 60) including multiple wavelengths.

The monitoring signal can be, for example, in an L-band (1561-1620 nm) having component wavelengths outside the transmission window from point A 402 to point B 404. However, the monitoring signal can be composed of any wavelengths, as long as those wavelengths are not included in the transmission window from point A 402 to point B 404 while within the transmission window of a given fiber. In some implementations, the monitoring signal is substantially between 1561 nm and 1700 nm.

FIG. 5 shows a block diagram of an example thin films filter 500. A substrate 502 is coated with a thin film 504. A second thin film 506 is further coated on thin film 504, and so on. A number of thin films, for example films 504, 506, 508, and 510, can be coated sequentially on the substrate 502. Each thin film can have a different thickness. Additionally, two consecutive films can have different refractive indices. In some implementations, the thickness of each thin film layer ranges from substantially 100 nm to 1000 nm. Additionally, a given thin films filter can have between substantially 10 to 20 layers.

When an input light 512 is incident to the filter 500, the light is partially reflected at every interface of two films with different refractive indices. The partially reflected light from all interfaces are denoted by rays 514, 516, 518, 520, and 522. The reflected lights interfere to form a reflected light 524.

The selection of the thickness and refractive index of each thin film, which can be done using, for example, a computer program, results in a specific wavelength (e.g., λ2) having a constructive interference at the reflected light 524. Thus, effectively, light of the specific wavelength λ2 will be fully reflected and contained in the reflected light 524. The transmitted light 526 will have no component of the reflected wavelength, since the sum of the reflected light 524 and the transmitted light 526 is the same as the input light 512.

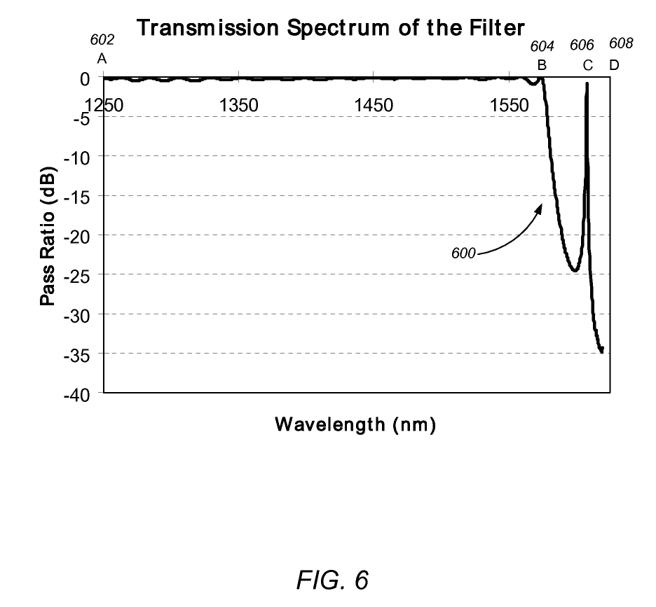

An individual can design a thin films filter (e.g., using some computer programs), which will reflect certain wavelengths and transmits other wavelengths. However, particular transmission curves can be difficult to design and construct. For example, a standard transmission curve has a band (window) only or a peak only, but not both band and peak (e.g., separated by some specified range of wavelengths). However, as shown in FIG. 6, a thin films structure for a filter can provide a unique transmission curve having a band and a peak.

FIG. 6 shows an example logarithmic transmission function 600 of a thin films filter. The transmission function 600 can be calculated (e.g., using a computer), using numerical data associated with the thin films structure of the filter, for example, the thickness and refractive index of each film. A filtering device (e.g., filtering device 42 of FIG. 2) includes a thin films filter having a particular transmission function. The transmission function 600 shows an example transmission pass ratio for a particular thin films filter of a filtering device. Note that 0 dB represents 100% passed, −6 dB is 25%, −20 dB is 1%, and −40 dB is 0.01%.

For example, as compared with the transmission function 400 of FIG. 4, the filter is designed specifically to provide a transmission function in the wavelength span from point A 402 to point D 408 of FIG. 4 (corresponding to points A 602 to point D 608 of FIG. 6), where points A and D are positioned substantially at 1250 nm and 1620 nm, respectively. This corresponds to the range shown in the transmission function 600 of FIG. 6. Also, as shown in FIG. 4, the filter has a transmission window from point A 402 to point B 404 where point B 404 is positioned at substantially 1585 nm. In some implementations, the position of point B 404 is selected in a range from 1561 nm to 1585 nm.

The transmission window of the transmission function 600 is shown as having a range of substantially 100% transmission ratio from 602 to 604. In this example, point C 406 of FIG. 4 is positioned substantially at 1602 nm, which corresponds to point C 606 in FIG. 6. In some implementations, the position of point C 606 is selected such that the corresponding wavelength of point B 604 is less than wavelength of point C 606 and the wavelength of point C 606 is less than the wavelength of point D 608. A peak-width at substantially 25% (−6 dB) pass ratio level at point C 606 is substantially 1 nm. In some implementations, the peak-width has a value less than substantially 10 nm.

The transmission function for thin films filters shown in FIGS. 4 and 6 are examples. Other thin films filters of different transmission functions can be used, for example, having multiple transmission windows or peaks.

In some implementations, the monitoring signals can be selected to have wavelengths that are within a window from 1585 nm to 1700 nm. When two adjacent monitoring signals are separated by 1 nm (the peak-width at 25% level), then a total number of 55 distinct monitoring signals can be used. As a result, up to 55 branches in an optical fiber network can be individually monitored. In some implementations, the number of monitoring signals can be increased. For example, the filter can be constructed with a narrower peak-width (i.e., the crosstalk is reduced optically), or the monitoring system can use a discriminatory detection circuit (i.e., the crosstalk is removed electronically). In a discriminatory circuit, all monitoring signals (e.g., λ1, λ2, λ3, and λ4) can be detected, for example, an electronic processor can pick signals exceeding a specified threshold.

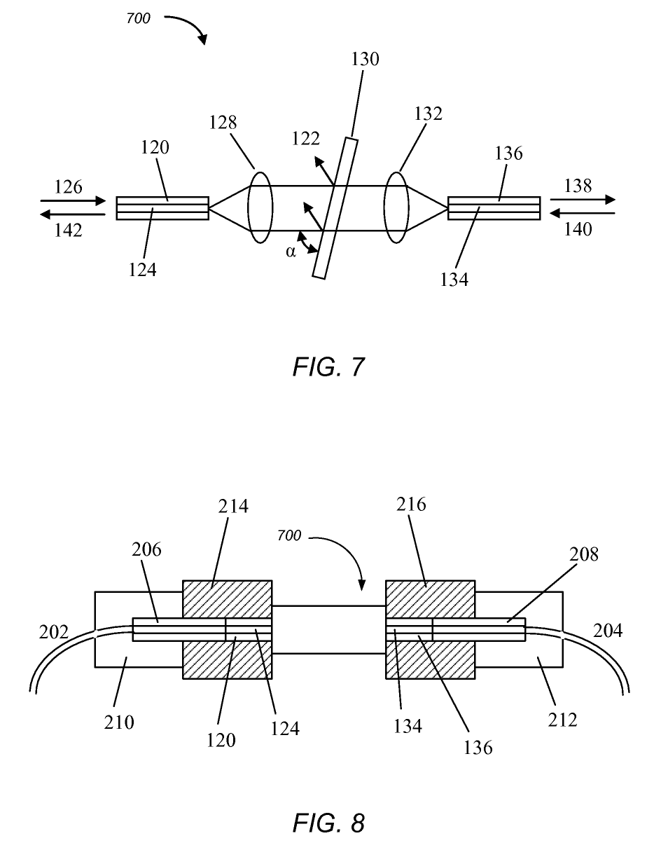

FIG. 7 shows an example filtering device 700. The filtering device 700 includes a ferrule 120, first lens 128, filter 130, second lens 132, and second ferrule 136. The first ferrule 120 is configured to hold a first fiber 124. The second ferrule 136 is configured to hold a second fiber 134.

Light 126 entering fiber 124 from outside the filtering device and then exiting fiber 124 is collimated using lens 128. The collimated light is incident onto the filter 130. The filter can be positioned at an angle relative to an axis of the incoming collimated light such that the filter 130 and the collimated light form an angle α (where a does not equal 90 degrees), so the collimated light is not normal to the filter 130.

For incoming light with transmitted wavelengths characterized in a transmission function, for example, as shown in FIGS. 4 and 6, the collimated light is transmitted through the filter 130. The collimated light transmitted through the filter 130 is focused using lens 132 and enters the second fiber 134 held using the second ferrule 136. Light 138 exits the filtering device 700 from fiber 134.

For incoming light with wavelengths not transmitted according to a transmission function (e.g., as shown in FIGS. 4 and 6), the filter 130 reflects the collimated light. Since the collimated light is not normal to the filter 130, reflected light 122 is off axis and thus does not re-enter the fiber 124.

Similarly, when light 140 enters the filtering device 700 through fiber 134, the transmitted light (e.g., light in the transmission band of the filter 130) exits fiber 124 as light 142. The light reflected from the filter 130 is off axis and does not re-enter fiber 134.

In some implementations, if the light incident onto the filter 130 in FIG. 7 is not collimated, i.e., the incident angle of light is not uniform, the peak at point C (406 of FIG. 4) can be broadened. The broadening is directly proportional to divergence of the light. However, the broadening of the peak at point C can increase the crosstalk among monitoring signals, e.g., λ1, λ2, λ3, and λ4, which, in turn, reduces the number of identifiable branches in an optical fiber network (e.g., fiber network 11 of FIG. 2).

FIG. 8 shows one implementation of the filtering device 700 joined with a first fiber 202 at a first side of the filtering device 700 and a second fiber 204 at a second side of the filtering device 700. One end of the first fiber 202 is held within a first ferrule 206 in a first connector 210. Similarly, one end of the second fiber 204 is held within a second ferrule 208 in a second connector 212. Both first ferrule 206 of first fiber 202 and first ferrule 120 of the filtering device 700 are held and kept in position using a first adaptor 214. In some implementations, the first adaptor 214 includes an alignment sleeve align and hold both ferrules. Similarly, second fiber 204 and the filtering device 700 are joined and held using a second adaptor 216. Alternatively, first and second adaptors 214 and 216 can be included in a mechanical housing of the filtering device 100.

As shown in FIG. 2, without filtering devices included in fiber network 11, branch fibers 22, 24, 26, and 28 are often connected to splitter 50 through standard fiber connectors such as SC (subscriber connector or single coupling), LC (Lucent connector), ST (straight tip or stab and twist), and MU (miniature unit-coupling) type connectors. Thus, each branch fiber can be easily disconnected from and reconnected to the splitter such that an installation, upgrade, or repair to the branch fiber or network components can be easily conducted.

As shown in FIG. 8, the first and second ferrules 120 and 136 of the filtering device 700 and their accompanying receptive parts (not shown) can be configured to mate to various types of connectors, for example, SC, LC, ST, MU, and others, in either PC (physical contact) or APC (angled polish connector) configuration. Therefore, an installer can easily include filtering devices 700 in the optical fiber network, for example, by first disconnecting branch fiber 22 from splitter 50 (FIG. 2) and then connecting one side of filtering device 700 to splitter 50 and the other side of device 700 to fiber 22 through fiber connectors, respectively.

In another embodiment, the filtering device 700 shown in FIG. 7 can include two fiber pigtails instead of connector-ready first and second ferrules 120 and 136.

In yet another implementation, the filtering device 700 shown in FIG. 7 can include another filter, instead of or in addition to, the filter having transmission characteristics as shown in FIG. 4 or 6. For example, a wavelength division multiplexing (WDM) filter or others can be used. For example, a connector-ready filtering device 700 can include a WDM filter as filter 130. The device 700 can be a two-port WDM filter and connected to a receiver (Rx) in an optical fiber network.

In further another implementation, the filter having transmission characteristics shown in FIG. 4 or 6 is not necessarily disposed in an optical setup such as a filtering device shown in FIG. 7 or 8. For example, the filter can be used as a stand alone element or in combination with other elements in an optical setup or device.

In some implementations, an OTDR device can also be used for detecting faults in a wavelength encoding fiber.

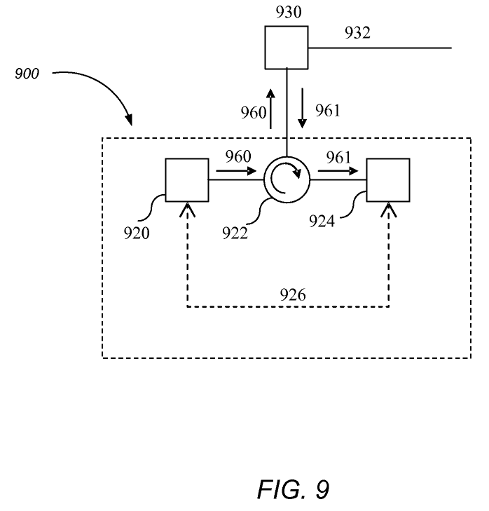

FIG. 9 shows an example monitoring device 900. The monitoring device 900 can be a particular type of monitoring device similar to the monitoring device 40 of FIG. 2. Monitoring device 900 includes a signal source 920, a circulator 922, and a receiver 924. The signal source 920 transmits a monitoring signal 960 having multiple wavelengths. Alternatively, the signal source 920 transmits a series of monitoring signals 960 sequentially, in which each signal has only one distinct wavelength.

The monitoring signal 960 is directed by the circulator 922 to a network through the main station 930 and a main fiber 932 corresponding, in some implementations, to the main station 30 and the main fiber 20 of FIG. 2. The reflected monitoring signal 961 from the network travels back to the circulator 922 through the main fiber 932 and the main station 930. The circulator 922 directs the reflected monitoring signal 961 to the receiver 924, where the signal is detected and processed. The receiver 924 can identify the wavelength of the reflected monitoring signal 961.

In some implementations, the intensity of the transmitted monitoring signal 960 can be modulated in the signal source 920. The modulation function is preferably a sine function, although other functions, e.g., a sawtooth, square, or other periodic or non-periodic functions, can be used as the modulation function. The phase of the intensity modulation function—not the phase of the light wave, of the reflected monitoring signal 961 from a reflector, e.g., reflecting element 52 of FIG. 2, is known, since the distances from the signal source 920 to the reflector, and from the reflector to the receiver 924 are known. The signal source 920 and the receiver 924 are joined electronically by a communication channel 926, so the processor in the receiver 924 can refer to the phase of the intensity modulation function at the signal source 920. Consequently, the signal from the reflector can be extracted from other scattering or randomly-reflected signals in the network. The intensity modulation of monitoring signal will improve the signal-to-noise ratio for the signal detection.

Furthermore, in the event of a fault in a particular fiber (e.g., a broken or damaged optical fiber), analyzing the phase of the intensity modulation function of the reflected monitoring signal allows the location of fault to be identified. Thus, the intensity modulation of monitoring signal will be able to identify fault's location without using an OTDR device.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described above should not be understood as requiring such separation in all embodiments.

Thus, particular embodiments of the invention have been described. Other embodiments are within the scope of the following claims. For example, the actions recited in the claims can be performed in a different order and still achieve desirable results.

What is claimed is:

1. A monitoring system comprising:
a fiber network including a plurality of branch fibers;
a main station coupled to a main fiber of the fiber network, the main station configured to broadcast communications signals to a plurality of branch stations coupled to the respective branch fibers of the plurality of branch fibers;
a monitoring device configured to transmit a monitoring signal and detect reflected portions of the monitoring signal such that the received portions of the monitoring signal specifically identify a condition of specific branch fibers of the plurality of branch fibers; and
a plurality of filtering devices coupled to each respective branch fiber, each filtering device including a transmission window configured to pass a plurality of communication wavelengths and a distinct wavelength of the monitoring signal, where the distinct wavelength is not within the transmission window, and block the remaining wavelengths, where the distinct wavelength identifies the respective branch fiber.

2. The monitoring system of claim 1, where the intensity of the monitoring signal is modulated by a modulating function.

3. The monitoring system of claim 2, where the modulating function is a periodic.

4. The monitoring system of claim 1, where the monitoring device includes a circulator coupled between a signal source and a receiver.

5. The monitoring system of claim 1, further comprising:
a splitter configured to separate the monitoring signals into each of the plurality of branch fibers.

6. The monitoring system of claim 1, further comprising:
a plurality of reflecting elements, each reflecting element being positioned along a corresponding branch fiber, each reflecting element being configured to reflect the particular wavelength passed by the corresponding filtering device of the branch fiber.

7. The monitoring system of claim 1, where each filtering device comprises:
a first fiber;
a first lens for collimating light exiting from the first fiber;
a filter for partially transmitting one or more transmission wavelengths and reflecting one or more reflection wavelengths of the collimated light according to a particular transmission function and where the reflection wavelengths do not exit the filtering device;
a second lens for focusing filtered light including the one or more transmission wavelengths transmitted by the filter; and
a second fiber for receiving focused light focused by the second lens.

8. The filtering device of claim 7, where the filtering device is configured to transmit particular wavelengths input to both the first fiber and the second fiber while blocking other wavelengths.

9. The filtering device of claim 7, wherein the transmission function of the filter includes the transmission window and a defined width peak corresponding to a particular monitoring wavelength, where the transmission window is separated from the peak by a specified range of non-passed wavelengths.

10. The filtering device of claim 9, where the transmission window is substantially between 1250 nm and 1585 nm.

11. The filtering device of claim 9, where a peak-width at a substantially 25% pass ratio of the defined width peak is less than 10 nm.

12. The filtering device of claim 9, where the transmission function of the filter covers substantially S-band and C-band, and includes a defined width peak substantially between 1561 nm and 1700 nm.

13. The filtering device of claim 9, where the filter is a thin films filter.

14. The filtering device of claim 7, where the filtering device is configured for coupling to a fiber connector selected from a group consisting of SC, LC, ST, and MU.

15. A method comprising:
receiving in a first direction one or more communications signals, the communications signals having wavelengths within a transmission window;
receiving in the first direction a monitoring signal, the monitoring signal including one or more wavelengths distinct from the wavelengths of the transmission window, where the wavelengths of the transmission window and the wavelengths of the monitoring signal are separated by a specified range of wavelengths;
passing the communications signals;
passing a particular wavelength of the monitoring signal; and
blocking all other wavelengths.

16. The method of claim 15, further comprising:
receiving from a second direction a reflected monitoring signal; and passing the reflected monitoring signal.

17. The method of claim 15, where an intensity of the monitoring signal is modulated by a modulating function.

18. An apparatus, comprising:
a thin films filter having a specified transmission function including a transmission window covering an S-band and a C-band and a defined width peak at a specified wavelength corresponding to a particular monitoring signal and not within the transmission window.

19. The apparatus of claim 18, where the apparatus is configured for coupling to a fiber connector selected from a group consisting of SC, LC, ST, and MU.

20. A system comprising:
a source configured to provide an optical signal having a plurality of wavelengths;
a plurality of filters disposed in distinct locations within an optical fiber network, each filter for partially transmitting one or more transmission wavelengths of the optical signal and reflecting one or more reflection wavelengths of the optical signal according to a particular transmission function, where the transmission function of each filter of the plurality of filters includes a transmission window including one or more communication wavelengths and a distinct transmission peak corresponding to a respective monitoring wavelength for the respective filter; and
a monitor configured to identify problems at particular locations in the optical fiber network according to wavelengths of the optical signal returned from the plurality of filters.

21. The system of claim 20, where an intensity of the optical signal is modulated by a modulating function.

22. The system of claim 21, where a phase of the returned intensity-modulated optical signal is analyzed to identify a location of fault at a specific fiber.

23. The system of claim 20, further comprising:
a plurality of reflecting elements, each reflecting element disposed along a fiber in the optical fiber network, each reflecting element of the plurality of reflecting elements being operable to reflect a particular monitoring wavelength passed by a filter.

24. The system of claim 23 where one or more of the plurality of reflecting elements is a coating at an end of a fiber.

25. The system of claim 23, where one or more of the plurality of reflecting elements is a filter disposed next to an end of a fiber.

26. The monitoring system of claim 2, where a phase of the received intensity-modulated monitoring signal is analyzed to identify a location of fault at a specific branch fiber.

27. The monitoring system of claim 6, where the reflecting element is a coating at an end of a fiber.

28. The monitoring system of claim 6, where the reflecting element is a filter coupled to an end of a fiber.

29. The method of claim 16, where a monitoring signal is reflected by a reflecting element disposed along a fiber.

30. The method of claim 29, where the reflecting element is a coating at an end of a fiber.

31. The method of claim 29, where the reflecting element is a filter coupled to an end of a fiber.

32. The method of claim 17, where a phase of the reflected intensity-modulated monitoring signal is analyzed to identify a location of fault.

33. An apparatus, comprising:
an optical fiber network including one or more fibers; and
a reflecting element at an end of a first fiber that reflects one or more monitoring wavelengths and transmits one or more communication wavelengths in the optical fiber network.

34. The apparatus of claim 33, where the reflecting element is a coating at an end of a fiber.

35. The apparatus of claim 33, where the reflecting element is a filter coupled to an end of a fiber.

36. An apparatus comprising:
a monitoring device including a transmitter and a receiver, the transmitter operable to transmit a monitoring signal to a fiber network having multiple branches and the receiver configured to receive reflected portions of the monitoring signal such that the received portions of the monitoring system identify a condition of a particular branch of the fiber network.

37. The apparatus of claim 36, further comprising:
a circulator operable to direct the monitoring signal from the transmitter to the fiber network and to direct received reflected portions of the monitoring signal to the receiver.

38. The apparatus of claim 36, where the monitoring signal includes a plurality of wavelengths, one or more wavelengths of the plurality of wavelengths being associated with each branch of the fiber network.

38. A method comprising:
transmitting a monitoring signal to a fiber network having a plurality of branches, the monitoring signal including a plurality of wavelengths;
receiving a reflected portion of the monitoring signal;
using the reflected portion of the monitoring signal to identify a condition of a particular branch of the fiber network.

39. The method of claim 38, where transmitting the monitoring signal includes transmitting one or more particular wavelengths for each particular branch of the fiber network.

40. The method of claim 38, where using the reflected portion of the monitoring signal further comprises identifying one or more wavelengths of the transmitted monitoring signal as missing wavelengths if the are not received or if they have a signal strength below a specified threshold.

41. The method of claim 40, further comprising:
determining one or more branches of the fiber network corresponding to the one or more missing wavelengths.
